(19) United States
(12) Patent Application Publication
(10) Pub. No.: US 2012/0226380 A1
(43) Pub. Date: Sep. 6, 2012

(54) DEVICE FOR STORING AND OUTPUTTING OBJECTS

(76) Inventors: Anatoli Stobbe, Barsinghausen (DE); Wilfried Herrmann, Hannover (DE)

(21) Appl. No.: 13/394,691

(22) PCT Filed: Jul. 1, 2010
(86) PCT No.: PCT/DE2010/000759

§ 371 Date: May 18, 2012

(30) Foreign Application Priority Data
Sep. 18, 2009 (DE) 10 2009 041 820.2

(51) Int. Cl. G06F 17/00; B65D 83/00; G06F 7/00

(52) U.S. Cl. 700/237; 221/208

(57) ABSTRACT

A device for storing and outputting objects includes a storage container, holders, an output shaft, and a controllable holding and releasing device. The holders comprise stationary insertion shafts, in which insertion tags connected to the objects are inserted. The insertion tags can be locked or released in the insertion shafts by the controllable holding and releasing device. Upon release, the insertion tags can be transferred independently from the insertion shafts into the output shaft under gravitational force and/or spring force.

### BACKGROUND OF THE INVENTION

1. Field of the Invention

The present invention relates generally to a device for storing and outputting objects.

2. Description of the Related Art

Vending machines, from which goods must be transported from a storage shelf to an output shaft in a motor-driven manner after payment and compartment choice, are known. Machines for providing valuables also operate with a motor-driven transport device. However, this process is time-consuming.

### SUMMARY OF THE INVENTION

An object of the present invention is to provide a device for storing and outputting objects that simplifies and accelerates the transfer of stored objects from a closed area into a public area after a release examination has been carried out.

This object of the invention is solved by providing a device for storing and outputting objects, which includes a storage container, holders, an output shaft, and a controllable holding and releasing device. The holders comprise stationary insertion shafts, in which insertion tags connected to the objects are inserted. The insertion tags can be locked or released in the insertion shafts by the controllable holding and releasing device. Upon release, the insertion tags can be transferred independently from the insertion shafts into the output shaft under gravitational force and/or spring force. Further developments and advantageous embodiments of the invention are also described herein.

In the present invention, the objects, which are to be stored and output, are provided with insertion tags. The insertion tags, in turn, are stored in insertion shafts. Through this, uniform insertion tags and insertion shafts can be used universally for objects of different designs. Only a good interaction between insertion tags and insertion shafts is necessary for the optimization of the output speed. Differences of the objects, however, do not have any effect.

The transfer of an object from the storage container into the output shaft takes place under gravitational force and/or spring force. The transfer can thus be initiated by means of simply releasing the controllable releasing device. The subsequent transfer, however, no longer requires its own drive. The releasing device can thus be designed constructively in a very simple manner and can be designed to be maintenance-free and to have a high degree of reliability and a long service life.

Preferably, the insertion shafts are oriented with longitudinal center axes thereof inclined to a horizontal, and insertion openings of the insertion shafts are pointed downwards.

Due to the inclined orientation of the longitudinal center axes of the insertion shafts to a horizontal, the insertion tags can independently overcome the initial adhesive friction after being released and can slip into the output shaft. Likewise, however, a loading of the releasing device by the weight of a heavy object is also avoided. The force, which must be applied for the release, can thus be reduced. In the case of an inclined orientation of the longitudinal center axes of the insertion shafts, a plurality of rows of insertion shafts can additionally be cascaded vertically, so as to accommodate a plurality of insertion shafts, if possible. It is then not necessary to increase the installation depth of the device.

According to a further development, the controllable releasing device comprises at each insertion shaft a latch, which can be operated electromagnetically. In the deactivated state of the electromagnet, the latch engages with an annular groove of the inserted insertion tag under spring force. The controllable releasing device can be activated by means of control commands. The latch is lifted out of the annular groove of the inserted insertion tag in the activated state of the electromagnet.

In the case of this embodiment, no electrical energy is required for simply storing the objects. In the event of a power failure, the objects also stay in place. Only a short energy pulse is required in response to a release command. The actual mechanical transfer from the storage to the output shaft takes place subsequently without further delay. No further electrical energy is required for this, but only gravitational force. The transfer speed is thus very fast.

The controllable releasing device can be controlled by means of an inputting or reading unit as a function of an access key. Through this, a corresponding object can only be removed when an access key is known. Manipulations and mix-ups can thus be avoided.

Preferably, the insertion tags comprise small detection plates, which can be read in a contact-free manner. The detection plates comprise electronically stored identification information. The insertion shafts comprise reading devices for the identification information. An evaluation device is connected to the controllable releasing device, and the controllable releasing device is additionally controlled as a function of the read identification information of the insertion tags.

By reading and evaluating identification information, the allocation, presence or absence of objects can be examined and tracked per se. The contact-free reading of information is furthermore also possible in response to a contamination of the object and is not subject to mechanical wear of the contacts. By means of the reading device, which is arranged at each insertion slot, the specific monitoring of the insertion slots is possible.

The identification information of stored insertion tags can be stored so as to be linked with the local insertion shaft thereof or can be stored intermediately. The insertion shaft of an insertion tag, which is to be released, can then be released by the controllable releasing device via the identification information, which is linked to the local insertion slot.

The storage of objects by means of insertion tags in insertion shafts is not limited to previously determined insertion slots. Instead, the insertion slots can be equipped in an unsystematic manner. This provides for the storage and administration of a plurality of objects in circulation and for a quick equipping or re-equipping of the insertion slots after the objects have been returned.

In a further development, a returning device for the objects is connected to the evaluation device. The returning device comprises an insertion shaft comprising a reading device and a latch, which can be operated electromagnetically. In the case of correct identification information of an inserted insertion tag, the latch can be activated and engages with an annular groove of the inserted insertion tag. In the deactivated state, the latch remains lifted out of the annular groove of the inserted insertion tag.

By coupling the returning device to the evaluation device, a complete tracking and logging of objects, which have been output and which are in circulation, is possible. The insertion shaft in the returning device makes it possible to limit the return of objects to only those with a valid identification number. Other objects are rejected due to the passivity of the returning device.

Due to the fact that provision is made for only one returning device, the reading and evaluation process takes place without delay, so that a user must not accept any wait time, as could otherwise occur in the case of multiplex arrangements.

The returning device also includes a transfer and unloading device for transferring the inserted insertion tag to the connected object from a public area into a closed area, and for unloading the object in the closed area.

A valid return and subsequent automatic securing of the object is made possible through the transfer and unloading device. The user can be provided with a receipt for this process, so that he can return an object within a short period of time and must not accept any delays caused by routes and wait times until the object has been safely deposited.

### BRIEF DESCRIPTION OF THE DRAWINGS

The invention will be explained below by means of an exemplary embodiment, which is illustrated in the drawings. In the drawings:

FIG. 1 shows an outputting unit of the device according to the invention in a sectional view; and

FIG. 2 shows a returning unit of the device according to the invention in a sectional view.

### DETAILED DESCRIPTION OF THE INVENTION

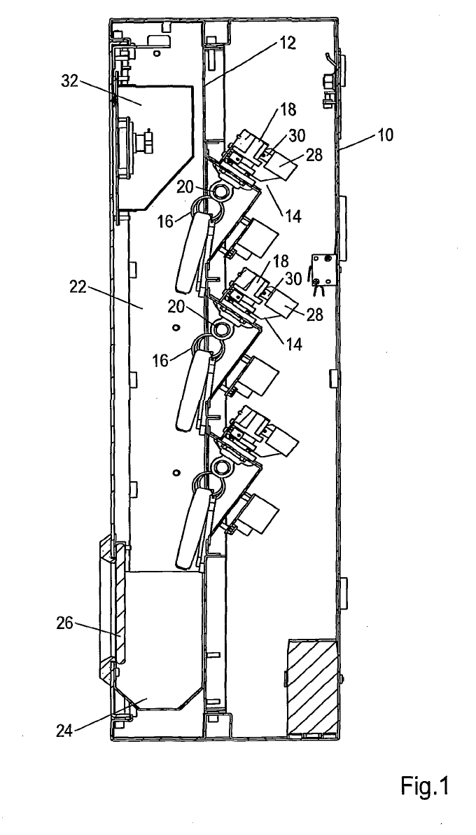

FIG. 1 shows a device for storing and outputting objects. The device comprises a storage container 10, which can be embodied as a wall cabinet. An assembly frame 12, at which holders 14 for storing objects 16 are arranged, is located in the storage container 10. The holders 14 are arranged next to one another in rows and are cascaded in three levels above one another in the exemplary embodiment. The holders 14 comprise stationary insertion shafts 18, in which insertion tags 20 connected to the objects 16 are inserted. Based on their longitudinal center axes, the insertion shafts 18 are oriented so as to be inclined to a horizontal. Insertion openings of the insertion shafts 18 point obliquely downwards. All of the openings of the insertion shafts 18 end in an output shaft 22, which is limited on the bottom by means of an output bin 24. The output bin 24 can be accessed from the outside through an output flap 26. To fix or release objects 16, respectively, each insertion shaft 18 is equipped with a latch, which can be operated electromagnetically. The latch comprises in each case an electromagnet 28 comprising an anchor 30, which is prestressed under spring force.

In the inserted state of an insertion tag 20, the anchor 30 engages with an annular groove of the insertion tag 20 and thus blocks the insertion tag 20 from being pulled out or from falling out of the insertion shaft 18. In response to the activation of the electromagnet 28, the anchor 30 is lifted out of the annular groove of the insertion tag 20 against the force of the spring, whereupon the insertion tag 20 with the object 16 fastened thereto is transferred from the insertion shaft 18 into the output shaft 22 and finally falls into the output bin 24 under gravitational force. The control of the electromagnets 28 takes place by means of a controllable releasing device 32, which, in turn, can comprise control electronics and additionally a keypad, a card reader, a barcode reader and a display.

The insertion tags 20 are furthermore equipped with small detection plates, which can be read in a contact-free manner, comprising electronically stored identification information. The insertion shafts 18 comprise reading devices for the identification information. The reading devices are connected to an evaluation device, which, in turn, is connected to the controllable releasing device 32 or which is a part of the controllable releasing device. The releasing commands can be transmitted specifically to electromagnets 28 of the insertion shafts 18 by means of the stored identification information and the local information of the insertion shafts 18. By checking the identification information, it can furthermore be verified that the object 16 with the corresponding insertion tag 20 has indeed left the insertion shaft 18.

The invention can be used, for example, for outputting keys to customers of a car rental company. It is assumed that a number of insertion tags 20 is connected to the corresponding keys for the rental cars, and that they are stored in insertion shafts 18. To get to the vehicle key, which is intended for him, the customer receives a PIN code, which he must input via an input keypad, or an authorization card, which is read automatically by the card reader. The control electronics knows the identification information of the insertion tag 18, which is associated with the PIN code, whereupon the controllable releasing device 32 specifically activates the electromagnet 28 of the corresponding insertion shaft 18 and initiates the outputting of the object 16 by releasing the insertion tag 20 out of the insertion shaft 18. The object 16 then falls into the output shaft 22 and reaches the output bin 24. The customer can now remove the object 16 through output flap 26 and use it.

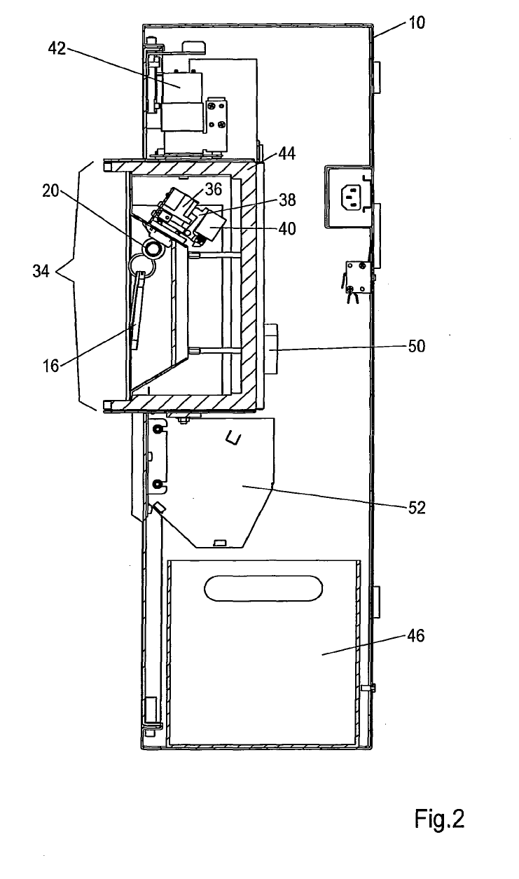

FIG. 2 shows a returning unit of the device according to the invention in a sectional view. In the same or in a further storage container 10, a returning device 34 is arranged, which is connected to the evaluation device of the device. The returning device 34 comprises an insertion shaft 36, which can be designed analogously to the insertion shafts of the outputting unit. The insertion shaft 36 comprises a latch, which can be operated electromagnetically. The latch of the insertion shaft 36 comprises an electromagnet 40 and a spring-loaded anchor 38. In this case, the insertion shaft 36, in turn, is again inclined to a horizontal, based on the longitudinal center axis. The insertion opening is oriented downwards. The insertion shaft 36 is integrated in a rotary cylinder 44, which is driven by means of a drive motor 42. An object collection box 46 is located below the rotary cylinder 44 in the interior of the storage container 10.

A receipt printer 50 comprising a receipt output bin 52 is furthermore arranged within the storage container 10.

The device is suitable for returning objects 16, for example keys for rental cars, after returning the vehicle. A customer inserts the insertion tag 20 of an object 16, which is to be returned, into the insertion shaft 36 of the returning unit. In the event that it is a valid object 16, which is to be returned, the identification number of the insertion tag 20 is read and verified in a contact-free manner. The electromagnet 40 is then activated, and the anchor 38 of the electromagnet 40 glides into the annular groove of the insertion tag 20 and holds it. Subsequently, the rotary cylinder 44 transfers the object 16 into the interior of the storage container 10. As soon as the object 16 is located in the interior of the storage container 10, the insertion tag 20 is released and drops into the object collection box 46 under gravitational force and thus into the secured area. A receipt, which drops into the receipt output bin 52 and which can be removed by the customer, is subsequently printed out for the customer by means of the receipt printer 50. The rotary cylinder 44 then returns into the initial position, so that a further object can be returned.

However, if it is an unidentifiable insertion tag 20, the electromagnet 40 of the insertion shaft 36 remains passive and the insertion tag 20 is not fixed in the insertion shaft 36. Instead, it keeps sliding out as soon as it is released. Contrary to the insertion shafts 18 of the outputting unit, the anchor 38 is controlled inversely here. In the deactivated state, the anchor 38 is located outside of the area of an annular groove. The anchor 38 only engages with the annular groove in the activated state, which causes the anchor 38 to hold the insertion tag 20 in the insertion shaft 36 until the rotary cylinder 44 has been rotated into the interior of the storage container 10 and until the insertion tag 20 with the object 16 can be released.

1. A device for storing and outputting objects, comprising:
a storage container;
holders;
an output shaft; and
a controllable holding and releasing device;
wherein the holders comprise stationary insertion shafts, in which insertion tags connected to the objects are inserted, wherein the insertion tags can be locked or released in the insertion shafts by the controllable holding and releasing device and, upon release, can be transferred independently from the insertion shafts into the output shaft under gravitational force and/or spring force.

2. The device according to claim 1, wherein the insertion shafts are oriented so that longitudinal center axes thereof are inclined to a horizontal, and insertion openings of the insertion shafts point downwards.

3. The device according to claim 1, wherein the controllable holding and releasing device comprises at each insertion shaft a latch, which can be operated electromagnetically, said latch comprising an electromagnet that can be activated by means of control commands, and said latch being arranged so that in a deactivated state of the electromagnet the latch engages with an annular groove of the inserted insertion tag under spring force, and in an activated state of the electromagnet the latch is lifted out of the annular groove of the inserted insertion tag.

4. The device according to claim 1, wherein the controllable holding and releasing device is controlled by means of an inputting or reading unit as a function of an access key.

5. The device according to claim 1, wherein the insertion tags comprise small detection plates, which can be read in a contact-free manner, said detection plates comprise electronically stored identification information, and the insertion shafts comprise reading devices for reading the identification information, and further comprising an evaluation device connected to the controllable holding and releasing device, and wherein the controllable holding and releasing device is controlled as a function of the read identification information of the insertion tags.

6. The device according to claim 5, wherein the identification information of stored insertion tags is stored so as to be linked with a corresponding one of said insertion shafts or is stored intermediately, and the insertion shaft of an insertion tag, which is to be released, can then be released by the controllable holding and releasing device via the identification information.

7. The device according to claim 5, wherein a returning device for the objects is connected to the evaluation device, wherein the returning device comprises a return insertion shaft comprising a reading device and a latch, said latch of the returning device being operable electromagnetically so that in the case of correct identification information of an inserted insertion tag, the latch of the returning device is activated to engage with an annular groove of the inserted insertion tag, and when the latch of the returning device is deactivated the latch of the returning device is lifted out of the annular groove.

8. The device according to claim 7, wherein the returning device comprises a transfer and unloading device operable to transfer the inserted insertion tag to the connected object from a public area into a closed area and to unload the connected object in the closed area.
